(19) United States
(12) Patent Application Publication
(10) Pub. No.: US 2011/0302567 A1
(43) Pub. Date: Dec. 8, 2011

(54) UPDATING SOFTWARE IN AN INFORMATION HANDLING SYSTEM

(75) Inventors: Adriana Kobylak, Round Rock, TX (US); Vandana Singhal, Austin, TX (US); Robert J. Soltis, Endicott, NY (US)

(73) Assignee: INTERNATIONAL BUSINESS MACHINES CORPORATION, Armonk, NY (US)

(21) Appl. No.: 12/795,068

(22) Filed: Jun. 7, 2010

(51) Int. Cl. G06F 9/44

(52) U.S. Cl. 717/168

(57) ABSTRACT

For updating software in a memory, a table of contents is received. The table of contents includes a complete list of files of an updated version of the software. A subset is received of the files of the updated version of the software. The subset is written for storage in the memory to update a superseded version of the software, so that the updated version of the software is stored in the memory by the writing of the subset. In the memory, files of the superseded version of the software are deleted if they are unlisted in the table of contents.

### BACKGROUND

The disclosures herein relate in general to information handling systems, and in particular to updating software in an information handling system.

Even if a server computer (e.g., rack-mount server or blade server) of an information handling system (“IHS”) does not have a graphical user interface (“GUI”), it may be operated remotely through a network interface of the IHS. For example, the IHS may also include a hardware management console (“HMC”) system (e.g., laptop computer) for connection to the server computer through the network interface. In that manner, the HMC system may remotely operate the server computer through the network interface, under control of a human user who operates a GUI of the HMC system.

For example, the HMC system may output (to the server computer through the network interface) commands for updating embedded software (e.g., firmware) on the server computer, such as by commanding the server computer to receive and store an updated version of files from the HMC system. The software may include multiple files, including: (a) a first subset of files that are being updated; and (b) a second subset of files that are not being updated. Within the second subset of files: (a) one or more files may cease being necessary (e.g., may become deprecated) for proper operation of the server computer (when the server computer is so operated with the updated version of the software); and (b) other files may continue being necessary for proper operation of the server computer (when the server computer is so operated with the updated version of the software). If one or more files (e.g., within the second subset of files) cease being necessary for proper operation of the server computer, yet are not deleted, then: (a) potentially scarce memory space is undesirably occupied by such unnecessary files on the server computer; and (b) a risk exists that such unnecessary files may interfere with proper operation of the server computer.

Nevertheless, if the HMC system is provided for updating software of the server computer, then the HMC system may have information about the first subset of files that are being updated, while nevertheless lacking information about the second subset of files that are not being updated (e.g., lacking information about which files, if any, have ceased being necessary within the second subset of files). Accordingly, such lack of information (about the second subset of files) would interfere with the HMC system's ability to remotely delete such unnecessary files (within the second subset of files) on the server computer. Moreover, the HMC system may lack authority to remotely delete certain types of files on the server computer.

Likewise, the server computer may lack such information about which files, if any, have ceased being necessary within the second subset of files. Also, the server computer may be programmed to delete files in response to only delete commands from the HMC system. Even if the HMC system commands the server computer to delete the entire first subset of files and the entire second subset of files: (a) such deletion would consume additional time; and (b) the HMC system's lack of information about the second subset of files would interfere with the HMC system's ability to suitably update the software of the server computer, because some files (within the second subset of files) may continue being necessary for proper operation of the server computer.

### BRIEF SUMMARY

For updating software in a memory, a table of contents is received. The table of contents includes a complete list of files of an updated version of the software. A subset is received of the files of the updated version of the software. The subset is written for storage in the memory to update a superseded version of the software, so that the updated version of the software is stored in the memory by the writing of the subset. In the memory, files of the superseded version of the software are deleted if they are unlisted in the table of contents.

### BRIEF DESCRIPTION OF THE SEVERAL VIEWS OF THE DRAWINGS

FIG. 1 is a block diagram of an information handling system of the illustrative embodiment.

FIG. 2 is a conceptual illustration of firmware stored by a server of FIG. 1 before an update operation.

FIG. 3 is a conceptual illustration of firmware stored by the server of FIG. 1 after the update operation.

FIG. 4 is a conceptual illustration of firmware stored by the server of FIG. 1 after an acceptance operation.

FIG. 5 is a flowchart of the update operation performed by the server of FIG. 1.

### DETAILED DESCRIPTION

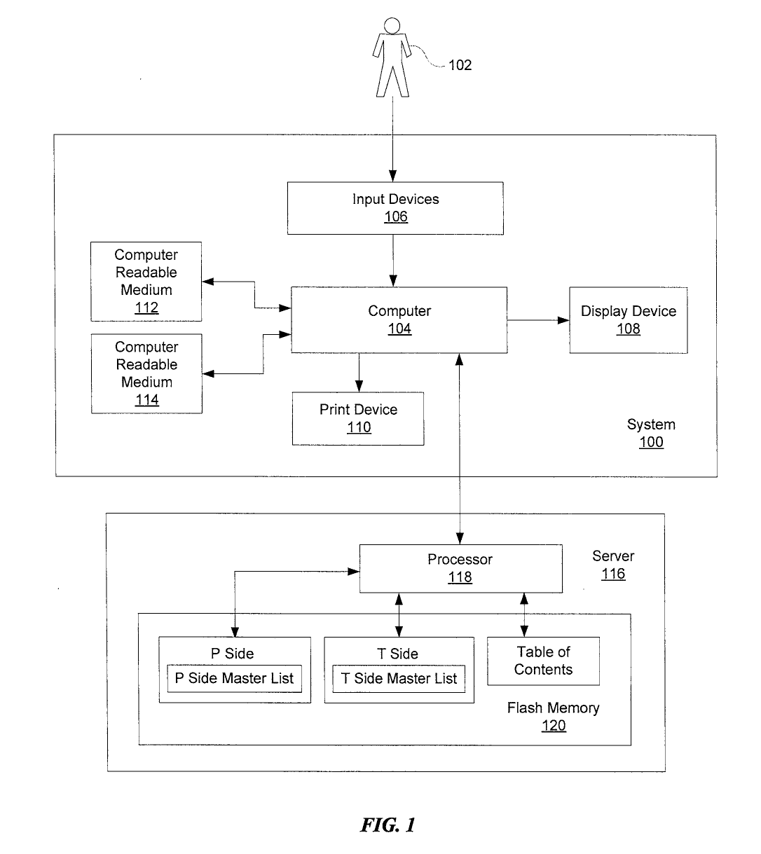

FIG. 1 is a block diagram of an information handling system (“IHS”) of the illustrative embodiment. The IHS includes a hardware management console (“HMC”) system 100. In the example of FIG. 1, the system 100 operates in association with a human user 102.

The system 100 is formed by various electronic circuitry components, including: (a) a general purpose computer 104, which is a general purpose computational resource such as a laptop computer, for executing and otherwise processing instructions, and for performing additional operations (e.g., communicating information) in response thereto; (b) input devices 106 for receiving information from the user 102; (c) a display device 108 (e.g., a conventional flat panel monitor) for displaying information to the user 102; (d) a print device 110 (e.g., a conventional electronic printer or plotter) for printing visual images on paper; (e) a computer readable medium (or apparatus) 112 (e.g., a hard disk drive or other nonvolatile storage device) for storing information; (f) a portable computer readable medium (or apparatus) 114 (e.g., a removable flash memory card or CD-ROM) for storing information; and (g) various other electronic circuitry for performing other operations of the system 100.

For example, the computer 104 includes: (a) a network interface (e.g., circuitry) for communicating between the computer 104 and a server 116 (e.g., outputting information to, and receiving information from, the server 116), such as by transferring information (e.g. instructions, data, signals) between the computer 104 and the server 116; and (b) a memory device (e.g., random access memory (“RAM”) device and/or read only memory (“ROM”) device) for storing information (e.g., instructions of software executed by the computer 104, and data processed by the computer 104 in response to such instructions). Accordingly, in the example of FIG. 1, the computer 104 is connected to the input devices 106, the display device 108, the print device 110, the computer readable medium 112, the computer readable medium 114 and the server 116, as shown in FIG. 1. The computer 104 executes: (a) operating system software (e.g., LINUX operating system software) for performing general purpose tasks; and (b) other processes and applications.

In response to signals from the computer 104, the display device 108 displays visual images, which represent information, and the user 102 views such visual images. Moreover, the user 102 operates the input devices 106 to output information to the computer 104, and the computer 104 receives such information from the input devices 106. Also, in response to signals from the computer 104, the print device 110 prints visual images on paper, and the user 102 views such visual images.

The input devices 106 include, for example, a conventional electronic keyboard (or keypad) and a pointing device, such as a conventional electronic “mouse,” rollerball or light pen. The user 102 operates the keyboard (or keypad) to output alphanumeric text information to the computer 104, which receives such alphanumeric text information. The user 102 operates the pointing device to output cursor-control information to the computer 104, and the computer 104 receives such cursor-control information. The input devices 106 also include, for example, touch-sensitive circuitry of a liquid crystal display (“LCD”) device.

Also, the IHS includes the server 116. In the illustrative embodiment, the server 116 is a server computer, such as a rack-mount server or blade server. As shown in FIG. 1, the server 116 includes a processor 118 and a flash memory 120. The flash memory 120 includes a “temporary” side (“T Side”), a “permanent” side (“P Side”), and a table of contents.

The T Side stores: (a) a most recently updated version of firmware for operation of the server 116; and (b) a T Side Master List, which is a list of files of such version. The P Side stores: (a) a most recently accepted version of firmware for operation of the server 116; and (b) a P Side Master List, which is a list of files of such version. Upon such acceptance, the processor 118: (a) replaces the P Side's version with the T Side's version; and (b) replaces the P Side Master List with the T Side Master List.

The system 100 outputs (to the processor 118 through the network interface) commands for updating the firmware on the T Side, such as by commanding the processor 118 to receive and store (on the T Side) an updated version of files from the system 100. In response to such commands, the processor 118: (a) writes such updated version for storage on the T Side; and (b) updates the T Side Master List accordingly.

Also, the system 100 outputs (to the processor 118 through the network interface) commands for updating the table of contents in the flash memory 120, such as by commanding the processor 118 to receive and store (in the flash memory 120) an updated version of the table of contents from the system 100. In response to such commands, the processor 118 writes such updated version for storage in the table of contents.

The table of contents is a most recently updated complete list of all files of the updated version of the firmware, which are necessary for proper operation of the server 116 (when the server 116 is so operated with the updated version of the firmware). The table of contents is created during a process of building the updated version of the firmware. The firmware may include multiple files, including: (a) a first subset of files that are being updated, so that such files would be listed in the table of contents; and (b) a second subset of files that are not being updated. Within the second subset of files: (a) one or more files may cease being necessary (e.g., may become deprecated) for proper operation of the server 116 (when the server 116 is so operated with the updated version of the firmware), so that such files would be unlisted in the table of contents; and (b) other files may continue being necessary for proper operation of the server 116 (when the server 116 is so operated with the updated version of the firmware), so that such files would be listed in the table of contents.

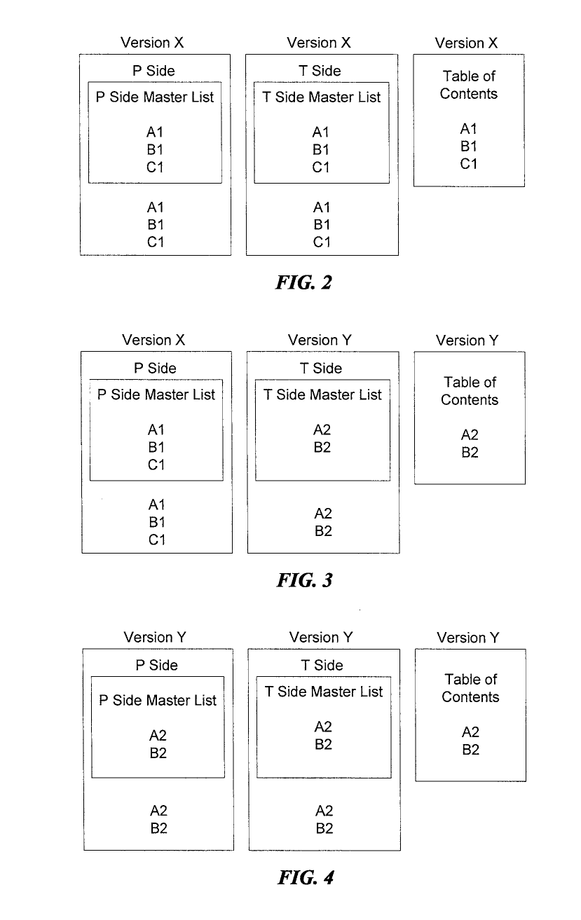

Within the second subset of files, if one or more files cease being necessary for proper operation of the server 116 (when the server 116 is so operated with the updated version of the firmware), then the processor 118 (as discussed hereinbelow in connection with FIGS. 2-5): (a) identifies such fact in response to the table of contents; (b) deletes such unnecessary files on the T Side; and (c) updates the T Side Master List accordingly. In that manner, the processor 118: (a) recovers flash memory 120 space that was being occupied by such unnecessary files, so that such space becomes available for other purposes; and (b) reduces a risk that such unnecessary files may interfere with proper operation of the server 116.

FIG. 2 is a conceptual illustration of firmware stored by the flash memory 120 before an update operation. In the example of FIG. 2: (a) for a version X of the firmware, the table of contents lists files A1, B1 and C1 as necessary for proper operation of the server 116; (b) the T Side stores such version X, so the T Side stores the files A1, B1 and C1, which are listed in the T Side Master List accordingly; and (c) likewise, the P Side stores such version X, so the P Side stores the files A1, B1 and C1, which are listed in the P Side Master List accordingly.

FIG. 3 is a conceptual illustration of firmware stored by the flash memory 120 after the update operation (e.g., after the system 100 outputs commands for updating the firmware on the T Side, such as by commanding the processor 118 to receive and store an updated version of files from the system 100 and an updated version of the table of contents from the system 100). In the example of FIG. 3: (a) for an updated version Y of the firmware, the table of contents lists files A2 and B2 as necessary for proper operation of the server 116; (b) the T Side stores such updated version Y, so the T Side stores the files A2 and B2, which are listed in the T Side Master List accordingly; and (c) the P Side continues to store the superseded version X of the firmware, so the P Side continues to store the files A1, B1 and C1, which are listed in the P Side Master List accordingly. In this manner, even if the update operation encounters an error (e.g., corruption), the server 116 may continue proper operation in response to the superseded version X of the firmware, which remains stored on the P Side.

FIG. 4 is a conceptual illustration of firmware stored by the flash memory 120 after an acceptance operation (e.g., after the server 116 determines that the update operation was successful), in which the processor 118: (a) replaces the P Side's version with the T Side's version; and (b) replaces the P Side Master List with the T Side Master List. Accordingly, in the example of FIG. 4: (a) for the updated version Y of the firmware, the table of contents continues to list the files A2 and B2 as necessary for proper operation of the server 116; (b) the T Side continues to store the updated version Y, so the T Side continues to store the files A2 and B2, which are listed in the T Side Master List accordingly; and (c) likewise, the P Side stores the updated version Y, so the P Side stores the files A2 and B2, which are listed in the P Side Master List accordingly.

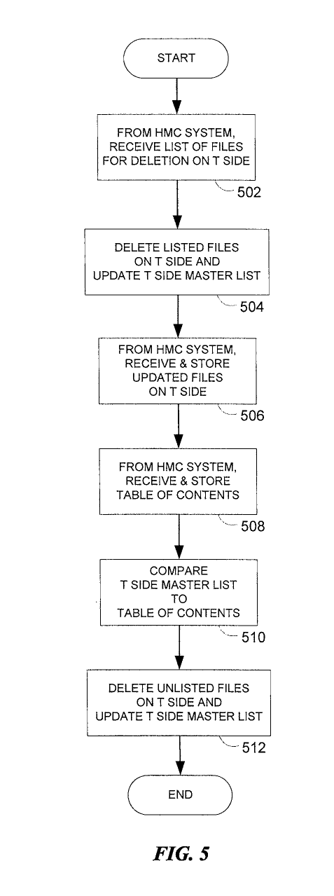

FIG. 5 is a flowchart of the update operation performed by the server 116. At a step 502, the processor 118 receives (from the system 100) a list of files for deletion on the T Side (“to-be-deleted files”). The system 100 determines the to-be-deleted files by: (a) commanding the processor 118 to read (and output to the system 100 through the network interface) the T Side Master List from the flash memory 120; (b) receiving the T Side Master List from the processor 118 through the network interface; (c) determining T Side Master List files (if any) within the first subset of files that are being updated (“to-be-replaced files”); and (d) if any to-be-replaced file belongs to a class of files that the system 100 is authorized to remotely delete, then listing such to-be-replaced file as a to-be-deleted file.

At a next step 504, the processor 118: (a) deletes the to-be-deleted files on the T Side; and (b) updates the T Side Master List accordingly.

At a next step 506, the processor 118 receives (from the system 100 through the network interface) the first subset of files that are being updated (“updated files”), and the processor 118 writes the first subset for storage on the T Side of the flash memory 120 to update a superseded version of the firmware, so that the updated version of the firmware is stored in the flash memory 120 by the writing of the first subset. Accordingly, the first subset is less than all of the files of the updated version of the firmware, yet the first subset is sufficient to update the superseded version of the firmware.

In response to the processor 118 starting the write of an updated file for storage on the T Side of the flash memory 120, the processor 118 marks such updated file as invalid in the T Side Master List. In response to the processor 118 successfully completing the write of such updated file for storage on the T Side of the flash memory 120, the processor 118 marks such updated file as valid in the T Side Master List. If any to-be-replaced file is not among the to-be-deleted files, then such to-be-replaced file is overwritten when the processor 118 writes the updated files for storage on the T Side of the flash memory 120.

At a next step 508, the processor 118 receives (from the system 100 through the network interface) an updated version of the table of contents, and the processor 118 writes such updated version for storage in the table of contents of the flash memory 120.

At a next step 510, by comparing the T Side Master List to the updated version of the table of contents, the processor 118 identifies all files (within the second subset of files) of the superseded version of the firmware that have ceased being necessary for proper operation of the server 116 (when the server 116 is so operated with the updated version of the firmware). At a next step 512, the processor 118: (a) deletes such unnecessary files on the T Side; and (b) updates the T Side Master List accordingly. In that manner, the processor 118: (a) recovers flash memory 120 space that was being occupied by such unnecessary files, so that such space becomes available for other purposes; and (b) reduces a risk that such unnecessary files may interfere with proper operation of the server 116.

As will be appreciated by one skilled in the art, aspects of the illustrative embodiments may be embodied as a system, method or computer program product. Accordingly, aspects of the illustrative embodiments may take the form of an entirely hardware embodiment, an entirely software embodiment (including, but not limited to, firmware, resident software, or microcode) or an embodiment combining software and hardware aspects that may all generally be referred to herein as a “circuit,” “module” or “system.” Furthermore, aspects of the illustrative embodiments may take the form of a computer program product embodied in one or more computer readable medium(s) having computer readable program code embodied thereon.

Any combination of one or more computer readable medium(s) may be used in the illustrative embodiment. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium (including, but not limited to, wireless, wireline, optical fiber cable, RF, or any suitable combination of the foregoing).

Computer program code for carrying out operations for aspects of the illustrative embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer, and partly on a remote computer or entirely on the remote computer or server. The remote computer may be connected to the user's computer through any type of network, including a local area network (LAN) or a wide area network (WAN), or the connection may be made to an external computer (for example, through the Internet using an Internet Service Provider).

Aspects of the illustrative embodiments are described with reference to flowchart illustrations and/or block diagrams of methods, apparatus (systems) and computer program products according to the illustrative embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions (which execute via the processor of the computer or other programmable data processing apparatus) are processable to cause performance of the functions/acts specified in the flowchart and/or block diagram block or blocks.

These computer program instructions may also be stored in a computer readable medium that can direct a computer, other programmable data processing apparatus, or other devices to operate in a particular manner, such that the instructions stored in the computer readable medium produce an article of manufacture, including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process, such that the instructions that execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to the illustrative embodiments. In this regard, each block in the flowchart or block diagrams may represent a module, segment, or portion of code, which includes one or more executable instructions for implementing the specified logical operation(s). In some alternative implementations, the operations noted in the block may occur out of the order noted in the Figures. For example, two blocks shown in succession may, in fact, be executed substantially concurrently, or the blocks may sometimes be executed in the reverse order, depending upon the functionality involved. Each block of the block diagrams and/or flowchart illustration, and combinations of blocks in the block diagrams and/or flowchart illustration, can be implemented by special purpose hardware-based systems that perform the specified operations or acts, or combinations of special purpose hardware and computer instructions.

The terminology used herein is for the purpose of describing particular embodiments only and is not intended to be limiting of the inventions. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description herein has been presented for purposes of illustration and description, but is not intended to be exhaustive or limited to the inventions in the form disclosed. Many modifications and variations will be apparent to those of ordinary skill in the art without departing from the scope and spirit of the inventions. The embodiment was chosen and described in order to best explain the principles of the inventions and the practical application, and to enable others of ordinary skill in the art to understand the inventions for various embodiments with various modifications as are suited to the particular use contemplated.

What is claimed is:

1. A method of updating software in a memory, wherein the method is performed by an information handling system, the method comprising:
receiving a table of contents that includes a complete list of files of an updated version of the software;
receiving a subset of the files of the updated version of the software;
writing the subset for storage in the memory to update a superseded version of the software, so that the updated version of the software is stored in the memory by the writing of the subset; and
in the memory, deleting files of the superseded version of the software that are unlisted in the table of contents.

2. The method of claim 1, wherein the subset is sufficient to update the superseded version of the software.

3. The method of claim 1, wherein the subset is less than all of the files of the updated version of the software.

4. The method of claim 1, and comprising:
in the memory, deleting at least a portion of a superseded version of the subset before the writing of the subset.

5. The method of claim 1, and comprising:
writing the table of contents for storage in the memory.

6. The method of claim 1, wherein the software is firmware.

7. A system for updating software, comprising:
a memory for storing the software; and
a processor for: receiving a table of contents that includes a complete list of files of an updated version of the software; receiving a subset of the files of the updated version of the software; writing the subset for storage in the memory to update a superseded version of the software, so that the updated version of the software is stored in the memory by the writing of the subset; and, in the memory, deleting files of the superseded version of the software that are unlisted in the table of contents.

8. The system of claim 7, wherein the subset is sufficient to update the superseded version of the software.

9. The system of claim 7, wherein the subset is less than all of the files of the updated version of the software.

10. The system of claim 7, wherein the processor is for: in the memory, deleting at least a portion of a superseded version of the subset before the writing of the subset.

11. The system of claim 7, wherein the processor is for: writing the table of contents for storage in the memory.

12. The system of claim 7, wherein the software is firmware.

13. A computer program product for updating software in a memory, the computer program product comprising:
a computer readable storage medium having computer readable program code embodied therewith, the computer readable program code comprising:
computer readable program code configured to: receive a table of contents that includes a complete list of files of an updated version of the software; receive a subset of the files of the updated version of the software; write the subset for storage in the memory to update a superseded version of the software, so that the updated version of the software is stored in the memory by the writing of the subset; and in the memory, delete files of the superseded version of the software that are unlisted in the table of contents

14. The computer program product of claim 13, wherein the subset is sufficient to update the superseded version of the software.

15. The computer program product of claim 13, wherein the subset is less than all of the files of the updated version of the software.

16. The computer program product of claim 13, wherein the computer readable program code is configured to: in the memory, delete at least a portion of a superseded version of the subset before the writing of the subset.

17. The computer program product of claim 13, wherein the computer readable program code is configured to: write the table of contents for storage in the memory.

18. The computer program product of claim 13, wherein the software is firmware.
